(19) United States
(12) Patent Application Publication
(10) Pub. No.: US 2010/0203209 A1
(43) Pub. Date: Aug. 12, 2010

(54) BEVERAGE BREWING PROCESS AND SYSTEM

(76) Inventors: William Fishbein, Santa Fe, NM (US); John Vavruska, Santa Fe, NM (US)

Correspondence Address: BARLOW, JOSEPHS & HOLMES, LTD., 101 DYER STREET, 5TH FLOOR, PROVIDENCE, RI, 02903, US

(21) Appl. No.: 12/703,075

(22) Filed: Feb. 9, 2010

Related U.S. Application Data
(60) Provisional application No. 61/152,008, filed on Feb. 12, 2009.

(51) Int. Cl. A23F 5/26; A47J 31/44; A47J 31/00; A47J 31/06; A47J 31/60; A23F 3/36

(52) U.S. Cl. 426/433; 99/281; 99/289 R; 99/300; 99/299; 99/290; 426/435

(57) ABSTRACT

The present invention provides a unique process and system for brewing beverages for retail or commercial use where the key brewing parameters are independently controlled to produce multi-cup batches of brewed beverage of optimum taste. This invention is applicable to both retail and commercial applications and is scalable in quantities ranging from one cup to three gallons or more of brewed beverage. Since the extraction and solid-liquid separation are conducted separately and independently, the present invention decouples these two operations to avoid reduction in taste quality while still being able to provide large multi-cup batches.

### CROSS REFERENCE TO RELATED APPLICATION

This application is related to and claims priority from earlier filed provisional patent application Ser. No. 61/152,008, filed Feb. 12, 2009, the entire contents thereof is incorporated herein by reference.

### BACKGROUND OF THE INVENTION

The invention relates generally to processes and systems for brewing beverages, such as coffee and tea. For ease of reference herein, the invention will be discussed in detail in connection with the brewing of coffee as the beverage. However, the present invention is in no way limited in scope to the brewing of coffee. It should be understood that any type of beverage may be brewed in accordance with the process and system of the present invention. For ease of discussion and by way of example, the present invention will be shown and discussed in detail in connection with the brewing of coffee.

By way of background, the brewing of coffee generally involves two key process operations: 1) batch extraction of water-soluble compounds from the roasted and ground coffee and 2) separation of the extract liquid (brewed coffee) from the extracted coffee solids. Coffee brewing is performed throughout the world by a wide variety of methods in equipment as simple as a pot over a fire for making “cowboy” coffee to sophisticated brewing machines for personal and commercial use in homes, cafes, restaurants, etc. Coffee makers range in size from those that produce a single-cup to several gallon batches. The present invention, with the capability to produce brewed beverage in quantities ranging from one cup to three gallons or more, is applicable to both the retail and commercial hot beverage specialty coffee trade.

There are a number of problems typically associated with prior art with the brewing of beverages, such as coffee, on a large-scale level. For example, a significant concern is the ability to produce large multi-cup batches while maintaining high quality of the resultant brewed beverage for the consumer. Commercial coffee brewers are forced to make coffee quickly to accommodate their customers need to be served and on their way. Unfortunately, the best way to brew coffee is not necessarily quickly, but rather patiently, allow brewing at uniform and optimum water temperature, uniform mixing of the ground coffee and water in a suspension, a gentle brew cycle, and most importantly, the proper time during which the coffee solids remain in contact with the water. Too long a contact time yields a bitter brew while insufficient time yields coffee with a strong sour taste.

This problem becomes more complicated as water rushes quickly through coarse-ground coffee and passes slowly through finely ground coffee, a natural dynamic that achieves just the opposite of the desired effect. Home brewing machines are able to accomplish this on a small scale, as each system honors the fundamental principle that the water and coffee remain in contact with each other in direct proportion to size of the ground coffee. The larger the grind the longer the brew, the smaller the grind the faster the brew. However, these systems would not work in a commercial setting for a number of reasons, including unit size, brewing time, brewed coffee batch quantity and clean up. Fast brewing systems brew too quickly and require the use of additional coffee to prevent a weak and bitter brew due to inadequate extraction. While using a higher coffee-to-water ratio does make a stronger brew, it compromises the quality of the final product.

In the prior art, there are no commercial machines that brew coffee in sufficient quantities and within the required time frame while honoring the stated fundamental principles of brewing great quality coffee. Attempts have been made to address these issues in the past by designing machines that brew one cup at a time. The quality issue has been moderately dealt with, but it is impossible to keep up with even the most modest consumer demands. Additionally, the costs of these machines have been extremely high.

There have been many attempts in the prior art to address the foregoing problems, namely, lower quality associated with larger batches of brewed beverages, such as multi-cup coffee batches. For example, several manufacturers of coffee brewing machines have tried to brew high quality coffee on a large scale. Bunn, Fetco, Curtis, Brewmatic and others have flooded the market with high production machines. Coffee, for large-scale production, is no longer brewed one pot at a time and is typically brewed far too quickly to extract a quality brew.

Typical prior art commercial machines use a flat bottom filter designed for the water to flow through the bed of coffee grounds as quickly as possible. Commercial machines that use flat bottom filters must use more coffee to over-compensate for the flat filter's quick brew cycle, a cycle that does not concentrate the coffee and water together and fails to deliver great quality coffee. Chemex and Melitta home brew systems use cone-shaped or v-shaped filters to concentrate the coffee and water together, resulting in fine tasting coffee, but this approach brews coffee too slowly for commercial use.

Further, the most common way to brew coffee is the automatic drip coffee brewer. Unfortunately, drip and percolation type coffee machines are generally unable to brew at the right temperature for the correct amount of time. Also, because the hot water must pass down through a deep bed of ground coffee solids by gravity, uniform exposure of all coffee grounds to the extraction water is not possible and bitter flavors result. These devices combine the brewing process with the filtration process and, hence, cannot independently control the key brewing variables listed previously.

Another example of a prior art brewing process and system is the “press pot” or “French press” coffee makers which come close to controlling the key brewing parameters in that there is a mixing step followed by a solid-liquid separation step. Press pots, however, have several inherent deficiencies and limitations. They are limited to relatively small batches of coffee. Also, complete separation of the fine coffee grounds from the extracted coffee is generally not possible due to inadequacies in the seal between the filter and the housing and in the relatively coarse screens used for the filtration. The fine particles suspended in a poured cup of coffee brewed in a French press coffee maker continue to extract soluble solids, which impart bitterness to the taste. These suspended particles can also give the brewed coffee a muddy appearance, especially when milk or cream is added, and produce a settled residue at the bottom of the cup, objectionable factors to many people. Also, in a French press, the extraction is generally conducted in a simple un-heated and non-insulated vessel that loses heat during the extraction, which takes place over several minutes. Hence, the extraction temperature decreases into a less than optimum range, such as less than 195° F.

Also, a machine sold under the trademark CLOVER is a recent automatic version of a French press that uses an inverted filter on a plunger along with vacuum to separate the liquid (brewed coffee) from the solids (coffee grounds). This machine is claimed to make the finest tasting brewed coffee, however, it is limited to only making a single cup of coffee at a time. This machine is also extremely expensive at around $11,000 US. Therefore, cost and coffee batch size are serious limitations to this machine, which is confined to use in a few high-end cafés that charge up to $22 for a single cup of coffee. The CLOVER machine requires the operator to manually stir the finely ground coffee after it has been combined with hot water for a period of one to two minutes. The CLOVER machine is limited to finely ground coffee to minimize brew time so that the operator does not have to spend several minutes stirring the coffee. When brewing is complete, the filter plunger rises as the vacuum pulls the brewed coffee liquid downward through the filter into a cup. At full upward extension, the filter is flush with the working surface where the coffee grounds are manually scraped off the filter.

Below is a list of patent references that further shows attempts in the prior art to improve the brewing of beverages, such as coffee.

U.S. Pat. No. 5,349,897—Coffee Brewer Method and Apparatus, Brian L. King and Paul A. King, Sep. 27, 1994.

U.S. Pat. No. 5,351,604—Coffee Brewer Method and Apparatus, Brian L. King and Paul A. King, Oct. 4, 1994.

U.S. Pat. No. 6,240,833 B1, Automatic French Press Beverage Maker, John C. K. Sham, et al, Jun. 5, 2001.

U.S. Pat. No. 6,422,133 B1, French Press Coffee maker with Assembly to Reduce Contact of Grounds with Liquid Coffee after Termination of Steeping Period, Frank A. Brady, Jul. 23, 2002.

U.S. Patent Application Pub. No. US2006/0260471 A1, Coffee or Tea Filtering Press, Alan J. Adler, Pub. Date Nov. 23, 2006.

U.S. Pat. No. 4,944,217, Automatic Coffee Brewing Apparatus, Sharky Watanabe, Jul. 31, 1990.

U.S. Pat. No. 7,237,475 B2, Cabinet Design for Filter Holder for Pressurized Espresso Machines, Andrew Yuen Chin Chen and Sum Fat Poon, Jul. 3, 2007.

U.S. Pat. No. 4,644,856, Apparatus for Brewing Espresso Coffee, Michael Borgmann, Feb. 24, 1987.

PCT Published Patent Application No. WO/2007/059275 for IMPROVED HOT BEVERAGE APPARATUS (This application is related to co-pending U.S. application Ser. No. 11/129041 and it claims priority from U.S. Provisional Application 60/737,344.).

U.S. Pat. No. 7,017,473 for a Coffee brewer, Jack Mazzola, Jr., Mar. 28, 2006.

U.S. Pat. No. 3,695,168 for Drip Coffee Maker, George van Brunt, Oct. 3, 1972.

U.S. Patent Application Pub. No. U52009/0095165, Published Apr. 16, 2009.

Notwithstanding these attempts, the prior art still fails to meet the demand for a high quality brewed beverage that can be made quickly and in large batches while still having a high quality taste.

### SUMMARY OF THE INVENTION

The present invention preserves the advantages of prior art beverage brewing devices, systems and processes. In addition, it provides new advantages not found in currently available devices, systems and processes and overcomes many disadvantages of such currently available devices, systems and processes.

The invention is generally directed to the novel and unique process and system for brewing beverages, such as coffee and other extractable beverages, such as tea. As stated above, the present invention is not limited to the brewing of coffee or tea but can brew any type of beverage. For ease of discussion, the present invention will be described in detail in connection with the brewing of coffee.

The present invention relates to the extraction of water-soluble compounds from any extractable beverage solids to produce a brewed beverage. The present invention provides a unique process and system for brewing beverages where the key brewing parameters are independently controlled to produce multi-cup batches of brewed beverage of optimum taste. This invention is applicable to both retail and commercial applications and is scalable in quantities ranging from one cup to three gallons or more of brewed beverage. For brewing of coffee, the key brewing variables are coffee grind size, brewing time (water-coffee contact time), exposure of ground coffee surfaces to uniform extraction conditions (constant and uniform liquid-solids mixing), uniform extraction temperature, and ratio of water-to-coffee (liquid-to-solid) in the mixing step. Further, since the extraction and solid-liquid separation are conducted separately and independently, the present invention decouples these two operations. Conducting these two operations separately avoids any reduction in taste quality, e.g. bitterness often associated with extensive exposure of brewed coffee to the non-uniform contact with coffee solids during slow filtration in deep beds of coffee grounds, such as in drip coffee makers. A method of self-cleaning of the brewer is also part of the present invention, as described below.

The present invention, unlike prior art processes and systems, controls the key brewing parameters, namely, brewing time (water-coffee contact time), exposure of ground coffee surface to uniform extraction conditions (constant gentle liquid-solids mixing in a suspension), uniform extraction temperature, and mass ratio of water-to-coffee (liquid-to-solid) in the mixing step. It is well known in the field of chemical engineering that the method that provides the most uniform batch contacting of fine solids with a liquid is a stirred tank reactor. The present invention solves the problem of uniform exposure of coffee grounds with water by contacting the solids and liquid as a mixed slurry, i.e. a mixed suspension of solids in liquid, rather than in a fixed bed of solids as in all previous coffee brewing concepts.

Other important brewing parameters include water quality, freshness of the ground coffee, and cleanliness of the brewing equipment. The first two of these parameters are beyond the scope of this invention while the cleanliness of the equipment is addressed in this invention through an automatic cleaning feature described herein. The invention further minimizes the contact time between the brewed coffee and the coffee grounds during filtration by performing a rapid filtration immediately following brewing. Hence, rather than attempting to accomplish the brewing (extraction) and solid-liquid separation (filtration) in a single step, these two key operations are conducted separately.

It is therefore an object of the present invention to provide a process and systems for brewing beverages that can produce the highest possible quality brewed coffee in batch sizes ranging from a single cup to three gallons or more for use in retail and commercial settings, and to do so quickly to accommodate customers in a hurry. More specifically, for a given coffee grind size, the object of the invention is to uniformly contact ground coffee with extraction water in a suspension of solids in liquid at the optimum combination of temperature and contact time.

As will be discussed in detail below, the present invention meets a need in the market for a beverage brewing process that can consistently produce multi-cup batches of the highest taste quality. In the case of coffee brewing, all multi-cup commercial coffee makers sacrifice brewed coffee taste quality due to combining the brewing and filtration steps and/or poor control of the key brewing parameters.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a schematic of the beverage brewing process of the present invention that uses a pump for slurry transfer;

FIG. 2 is a schematic of the beverage brewing process of the present invention that uses a vacuum for slurry transfer; and

FIG. 3 is a schematic of the beverage brewing process of the present invention that uses gravity for slurry transfer.

### DETAILED DESCRIPTION OF THE PREFERRED EMBODIMENT

The present invention approaches the coffee brewing process as a sequence of chemical engineering unit operations and optimizes the two key unit operations in the process, i.e. extraction (liquid-solid contacting) and filtration (solid-liquid separation). The process and system of the present invention is readily scalable, i.e. it can be scaled up or down to suit the coffee brewing capacity needs of a particular application from a single cup to three gallons or more. The invention ensures that the brew process adheres to all the principles of brewing great tasting coffee and does not compromise the quality of the coffee by rushing the brewing step. The invention brews ample quantities of coffee in the same time or even faster than current systems, but there is no compromise in the critical relationship between the size of the ground coffee and the length of time the two should remain in contact. The cost of a system made in accordance with the present invention will be similar to the cost of an average commercial coffee maker known in the industry today and it will be constructed to last a long time and be easily repaired.

The beverage brewing process and system of the present invention preferably consists of a continuously and gently mixed coffee extraction vessel in which a suspension of the solids in liquid is maintained, a pump (positive pressure) to transfer the slurry, and a filter to separate the suspended solids in the slurry from the brewed liquid. An alternative to a pump to transfer the slurry from the extraction vessel to the filter and to separate the solids in the slurry from the liquid is via a vacuum pump. A third embodiment consists of gravity transfer and filtration of the slurry and involves no positive pressure pump or vacuum pump. Each of the three embodiments of the invention is described and illustrated herein. Each unit operation is separately controlled to accommodate any type of ground beverage solids of any grind size and any desired brew time.

### Option 1: Slurry Transfer by Pump

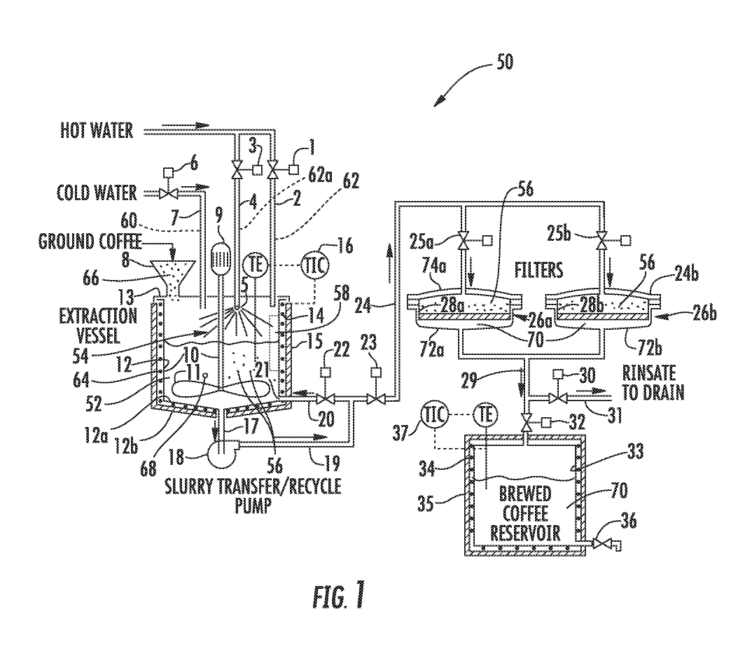

Referring first to FIG. 1, a first embodiment 50 of the present invention is shown. A schematic of the process and system of this first embodiment of the present invention is shown to include a pump 18 for the transfer of slurry 52. More specifically, with valve 23 closed, the extraction vessel 12 receives hot water 62 of the optimum temperature, preferably 195 to 205° F., from an external source (not shown) through an automatic valve 1 and line 2. Alternatively, the extraction vessel 12 can receive cold water 60 through an automatic valve 6 and line 7 for heating to the brewing temperature using optional electric heating elements 14 outside the walls 12a and bottom 12b of the extraction vessel 12. For ease of discussion, water is generally referenced as 64. The extraction vessel 12 is enshrouded with insulation 15 outside the heating elements 14 to facilitate the delivery of a uniform extraction temperature. A mechanical mixer 54 is positioned in the extraction vessel 12 for gentle agitation of the slurry 52 to maintain suspension of the coffee solids during extraction. The mixer 54 includes a motor 9, shaft 10, and impeller 11. The impeller 11 can be of a variety of types including flat blade, pitched blade, and propeller designs, however, the ratio of impeller diameter to extraction vessel diameter should be adequate to provide uniform mixing and suspension of solids in accordance with the present invention. The size and configuration of the mixer 54 can be modified to suit the beverage to be brewed. The rotation speed of the mixer 54 should be sufficient to maintain suspension of the solid particles during extraction. Optimally, to promote uniform and adequate mixing, one or more internal baffles 58 can be located along the inside walls 12a of the extraction vessel 12. The extraction vessel 12 has a removable lid 13 with appropriate apertures to permit water lines 2, 4, and 7, coffee hopper 8, and mixer shaft 10 to pass therethrough.

An alternative to the direct mechanical mixer just described for mixing the slurry is a magnetic stirrer in which a motor with magnetic element on its shaft, external to the extraction vessel, magnetically couples to a rotating mixing element inside the extraction vessel.

After the water 64 is heated to the desired extraction temperature, the mixer 54 is turned on and a ground extractable solid material 66, such as ground coffee, is added to the vessel 12 through hopper 8. The extraction process begins and continues for a pre-determined duration controlled either manually or by a programmable timer. Alternatively, if an external source of hot water 62 of the appropriate temperature is available, the dry ground coffee solids 66 can be added to the extraction vessel 12 first followed by the hot water 62. The temperature of the liquid 64 in the extraction vessel 12 is controlled by an automatic temperature control loop 16 which measures (temperature element—TE) and controls (temperature indicating controller—TIC) the temperature by varying the electric current to the electrical resistance heating elements 14. The heating elements 14 are enshrouded with insulation 15 to reduce heat losses.

An alternative to the mechanical mixer 54 previously described, or in conjunction with the mechanical mixer previously described, involves agitation by recycle of slurry, referenced as 68, via the slurry pump 18 back to the extraction vessel 12 through the pump discharge line 19 and recycle line 20. The slurry pump 18 can be any type of pump that reliably can transfer a slurry 68, such as a positive displacement or centrifugal pump. Jet entry of the slurry 68, including water 64 and particles 56, at port 21 into the extraction vessel 12, either radially or tangentially, at sufficient velocity and slightly above the bottom of the vessel promotes suspension and agitation of the coffee particles 56 during extraction. This alternative method of agitation requires two ON/OFF valves 22 and 23, which are set to either recycle the slurry 68 back to the extraction vessel 12 (recycle mode) or transfer the slurry 68 (transfer mode) to the dual filters, 26a and 26b. as described below. These valves 22 and 23 can be either manually or automatically operated.

When coffee extraction is complete based on the desired brewing time selected by the user and, if agitation by slurry recycle is not being used, the transfer pump 18 automatically turns on. The pump 18 receives coffee slurry 68 from the bottom center or bottom side of the extraction vessel 12 through line 17 and transfers the slurry 68 through lines 19 and 24 and through either valve 25a or 25b to one of the parallel in-line filter vessels 26a and 26b. Valves 25a and 25b can be set to direct slurry 68 to either filter 26a and 26b. For example, one of the filters 26a or 26b can receive slurry 68 while coffee grounds 56 are being removed from the other filter that is not receiving slurry 68 at that time. These valves 25a and 25b can be either manually or automatically operated. Any type of pump 18 that can transport coffee slurry 68 at, for example, 195 to 205° F. with sufficient pressure to force the liquid through the growing bed of coffee solids 56 in the filter vessel 26a and 26b in less than approximately 20 seconds, can be used, including centrifugal and positive displacement pumps.

In the filter vessels 26a and 26b, the brewed coffee 70 is rapidly separated from the extracted coffee solids with high efficiency. Each filter vessel 26a and 26b includes respective bases 72a, 72b and lids 74a, 74b, which mate to form a pressure/vacuum seal using O-rings or gaskets along with clamps, bolts, or a bayonet lock arrangement (such as in an espresso machine), or press fit to contain the liquid pressure during filtration of the slurry 68. O-rings and gaskets are so well known in the art, they need not be discussed in further detail herein. The filter vessels 26a and 26b each contain a removable filter basket 28a, 28b that collects the extracted coffee solids 56. An O-ring or gasket seal is also formed between the filter basket 28 and the filter vessel base 72a, 72b. The filter media in the filter basket 28 is preferably made of a fine stainless steel woven mesh or perforated plate. Preferably, two flat parallel filter media members are provided in the system of the present invention. However, filters of other shapes such as cones can also be used. Filters of different materials, configurations and mesh sizes can be used for optimum filtration of a particular coffee grind size.

Optionally, if desired, filter paper or other removable filter media can be placed on top of the woven mesh or perforated plate in the basket 28 for separation of even finer suspended coffee solids 56 from the brewed coffee slurry 68. The filter 28a, 28b is of sufficiently large cross-sectional flow area to produce a shallow bed of coffee grounds 56, which permits rapid filtration due to low liquid flow resistance. With this arrangement, additional contact time of the brewed coffee with the extracted coffee solids 56 is thereby minimized. Each filter vessel 26a, 26b is designed to withstand the liquid pressure required to force the brewed coffee liquid 70 through the growing bed of coffee solids 56 collected on the filter media 28a, 28b.

It should be understood that the filter media configuration of the system of the present invention is not limited to two parallel filters. More or less than two filters in parallel, such as one or three filters, can be used to suit the needs of the application. In the case of a design involving a single filter, the filter assembly 26a, 26b can be situated to allow easy changeout of a filter basket 28a, 28b containing coffee grounds 56 with a clean filter basket. Ease of filter changeout can be accomplished by an arrangement that allows for registration of the lid 74a, 74b with the base 72a, 72b and associated O-ring or gasket seals. For a single filter, the filter base 72a, 72b is first vertically separated from the filter lid 74a, 74b and the filter basket can be manually lifted out of the filter base directly or using, for example, an attached handle. Also, for a single filter, a pivot arrangement can be used in which the filter base 72a, 72b is attached to an adjacent vertical rod or shaft. In this pivot arrangement, the filter base 72a, 72b is first vertically separated from the filter lid 27, then swung horizontally away from the normal filter axis for access to the filter basket 28. A clean empty basket 28 is inserted into the filter base 72a, 72b and swung horizontally back into the normal filter axis, where the filter lid 74a, 74b and filter base 72a, 72b are brought back together vertically to form a pressure/vacuum seal. The motions for the filter disassembly and pivoting can be accomplished either manually or automatically.

Other methods of solid-liquid separation, including other types of filters, hydrocyclones and centrifuges, can be used as alternatives to the filter described above.

The brewed coffee 70 flows through line 29 and through valve 32 into the brewed coffee reservoir 33 where it is dispensed into cups via a tap 36 on an as-needed basis. The brewed coffee reservoir 33 is maintained at the desired coffee drinking temperature, such as 180 to 195° F., by a temperature control loop 37 which measures (temperature element—TE) and controls (temperature indicating controller—TIC) the temperature by varying the electric current to the electrical resistance heating elements 34. The heating elements 34 are enshrouded with insulation 35 to reduce heat losses. Alternatively, the brewed coffee reservoir can be insulated without a means of automatic temperature control as just described. A further alternative to external insulation of the brewed coffee reservoir is a double-wall vessel with a vacuum between the walls, as in a vacuum flask, thermos, or Dewar.

It should be noted that the brewing system 50 of the present invention can be made of any type of material that is suitable in the industry for the handling, transport and containment of beverages, namely hot beverages. For example, the extraction vessel 12, wetted parts of pump 54, filter vessels 26a, 26b and brewed coffee reservoir 33 are preferably made of 316L Stainless Steel, while the conduit lines are also preferably made of 316L Stainless Steel. Other materials of construction that meet the appropriate standards in the coffee brewing industry would also be acceptable in the present invention. Examples of polymeric materials that may be acceptable for pump wetted parts and conduits include, but may not be limited to, Polysulfone and Teflon. O-ring or gasket materials for seals in the filter units can include any elastomeric or polymeric materials that meet the appropriate standards in the coffee brewing industry under similar conditions.

The invention also provides a method of self-cleaning. After a brew cycle, when a self-cleaning switch is activated, hot water 62a is supplied through valve 3 and line 4 (instead of line 2) to a spray nozzle 5, which sprays hot water 62a throughout the extraction vessel, cleaning its interior surfaces of residues. The self-cleaning cycle automatically turns on the transfer pump 18, which transfers the rinsate through a filter vessel 26a, 26b that has been emptied of coffee grounds and discharges the rinsate through open valve 30 and line 31 to the drain. During the self-cleaning cycle, valve 32 is closed. More than one self-cleaning cycle may be required to adequately clean the apparatus.

### Option 2: Slurry Transfer and Filtration by Vacuum

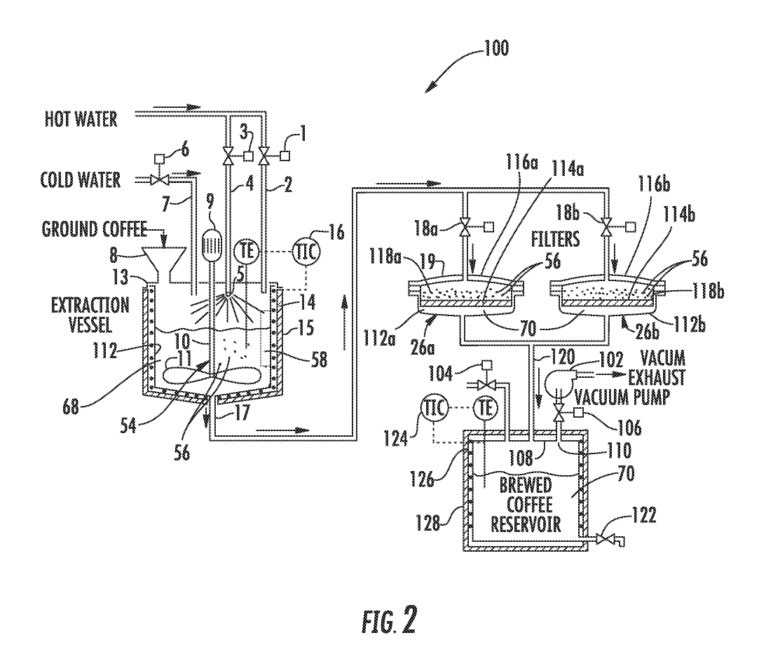

Turning now to FIG. 2, a schematic of the process and system of a second embodiment 100 of the present invention is shown where a vacuum pump 102 is used to transfer the slurry 68. Initially, valves 18a and 18b are closed. Valves 18a and 18b can be either manual shutoff valves or automatically actuated shutoff valves. The description of the brewing process of the present invention relating to the extraction process for embodiment 50 is the same for this embodiment 100. However, recycling of slurry 68 back to the extraction vessel 12, described previously as an alternative means of slurry agitation for embodiment 50, does not apply to this embodiment 100.

For the embodiment 100 in FIG. 2, when coffee extraction is complete based on the desired brewing time selected by the user, the vent valve 104 closes, the vacuum pump inlet valve 106 opens, and the vacuum pump 102 automatically turns on. As air is evacuated from the coffee reservoir 108 creating a vacuum, with respect to atmospheric pressure, coffee slurry 68 flows from the bottom of the extraction vessel 12 through line 17 and through either valve 18a or 18b to one of the parallel in-line filter vessels 26a and 26b. Valves 18a and 18b can be set to direct slurry 68 to either filter vessel 26a or 26b. For example, one of the filters 26a, 26b can receive slurry 68 while coffee grounds 56 are being removed from the other filter. As an alternative approach to achieving vacuum, with valves 104, 18a and 18b closed, the vacuum pump 102 is first turned on to evacuate the filter vessels 26a, 26b and coffee reservoir 108. Then, prior to beginning the extraction process, when the desired vacuum level is achieved, either vacuum pump isolation valve 106 can be closed and vacuum pump 102 shut off, or vacuum pump isolation valve 106 can remain open with vacuum pump 102 remaining on. When coffee extraction is complete, valves 18a or 18b are opened to direct slurry 68 to either filter vessel 26a or 26b. As an alternative to evacuating the brewed coffee reservoir 108 through inlet line 110, the vacuum pump 102 and vacuum pump inlet valve 106 can be connected to the side of each filter vessel base 112a and 112b to evacuate the filters 114a, 114b and brewed coffee reservoir 108.

In the filter vessels 26a, 26b, the brewed coffee 70 is rapidly separated from the extracted coffee solids 56 with high efficiency. Each filter vessel 26a, 26b consists of a base 112a, 112b and lid 116a, 116b, which mate to form a vacuum seal using O-rings or gaskets along with clamps, bolts, or a bayonet lock arrangement (such as in an espresso machine), or press fit to contain the liquid under vacuum during filtration of the slurry 68. The filter media 114a, 114b and configuration thereof may be the same as that employed in the first embodiment 50 of the present invention shown in FIG. 1. The filter vessels 26a and 26b each contain a removable filter basket 118a, 118b that collects the extracted coffee solids 56 and allows the coffee liquid 70 to pass therethrough. An O-ring or gasket seal is also formed between the filter basket 118a, 118b and the respective filter vessel bases 112a, 112b. The filter media 114a, 114b in the filter basket 118a, 118b is preferably a fine stainless steel woven mesh, preferably of 150 mesh size or smaller, or a perforated plate. Filters having different mesh sizes can be used for optimum filtration of a particular coffee grind size. Also, filters shapes other than right circular cylinders, such as cones, can be used.

Optionally, if desired, filter paper or other filter media can be placed on top of the woven mesh or perforated plate in the basket 118a, 118b for separation of even finer suspended coffee solids from the brewed coffee. The filter is of sufficiently large cross-sectional flow area to produce a shallow bed of coffee grounds, which permits rapid filtration, due to low liquid flow resistance. With this arrangement, additional contact time of the brewed coffee 70 with the extracted coffee solids 56 is thereby minimized. In this option, each filter vessel 26a, 26b is designed to withstand the vacuum required to pull the brewed coffee liquid 70 through the growing bed of coffee solids 56 collected on the filter media 114a, 114b. It should be understood that this option is also not limited to two parallel filters. More or less than two filters in parallel, such as one or three filters, can be used to suit the needs of the application. In the case of a design involving a single filter, the filter assembly can be situated to allow easy changeout of a filter basket containing coffee grounds with a clean basket. Ease of filter changeout can be accomplished by an arrangement that allows for registration of the lid 19 with the bases 112a, 112b and associated O-ring or gasket seals. For a single filter, the filter base 112a, 112b is first vertically separated from the filter lid 116a, 116b and the filter basket can be manually lifted out of the filter base directly or by using, for example, an attached handle. Also, for a single filter, a pivot arrangement can be used in which the filter base 112a, 112b is attached to an adjacent vertical rod or shaft. In this pivot arrangement, the filter base 112a, 112b is first vertically separated from the filter lid 116a, 116b, then swung horizontally away from the normal filter axis for access to the filter basket 118a, 118b. A clean empty basket 118a, 118b is inserted into the filter base 112a, 112b and swung horizontally back into the normal filter axis, where the filter lid 116a, 116b and filter base 112a, 112b are brought back together vertically to form a pressure/vacuum seal. The motions for the filter disassembly and pivoting can be accomplished either manually or automatically.

Other methods of solid-liquid separation including other types of filters, hydrocyclones and centrifuges can be used as alternatives to the filter just described.

The brewed coffee 70 flows through line 120 into the brewed coffee reservoir 108. When the slurry transfer and filtration are complete, the vacuum pump 102 shuts off, the vacuum pump inlet valve 106 is closed, and the vent valve 104 opens to return the brewed coffee reservoir 108 to atmospheric pressure. The brewed coffee 70 in the coffee reservoir 108 is ready to be dispensed into cups via a tap 122, on an as-needed basis. The brewed coffee reservoir 108 is maintained at the desired coffee drinking temperature, such as 180 to 195° F., by a temperature control loop 124 which measures (temperature element—TE) and controls (temperature indicating controller—TIC) the temperature by varying the electric current to the electrical resistance heating elements 126. The heating elements 126 are enshrouded with insulation 128 to reduce heat losses. Alternatively, the brewed coffee reservoir 108 can be insulated without a means of automatic temperature control as just described. A further alternative to external insulation of the brewed coffee reservoir is a double-wall vessel with a vacuum between the walls, as in a vacuum flask, thermos, or Dewar.

The second embodiment of the invention 100, shown in FIG. 2, also provides a method of self-cleaning in similar fashion to the embodiment 50 of FIG. 1. After a brew cycle, when a self-cleaning switch is activated, hot water is supplied through valve 3 and line 4 to a spray nozzle 5, which sprays hot water throughout the extraction vessel, cleaning its interior surfaces of residues. The self-cleaning cycle automatically turns on the vacuum pump 102, opens valve 106 and closes the vent valve 104, which transfers the rinsate through a filter vessel that has been emptied of coffee grounds and discharges the rinsate into the brewed coffee reservoir 108. The rinsate is then drained through valve 122 to the drain. More than one self-cleaning cycle may be required to adequately clean the apparatus.

### Option 3: Slurry Transfer and Filtration by Gravity

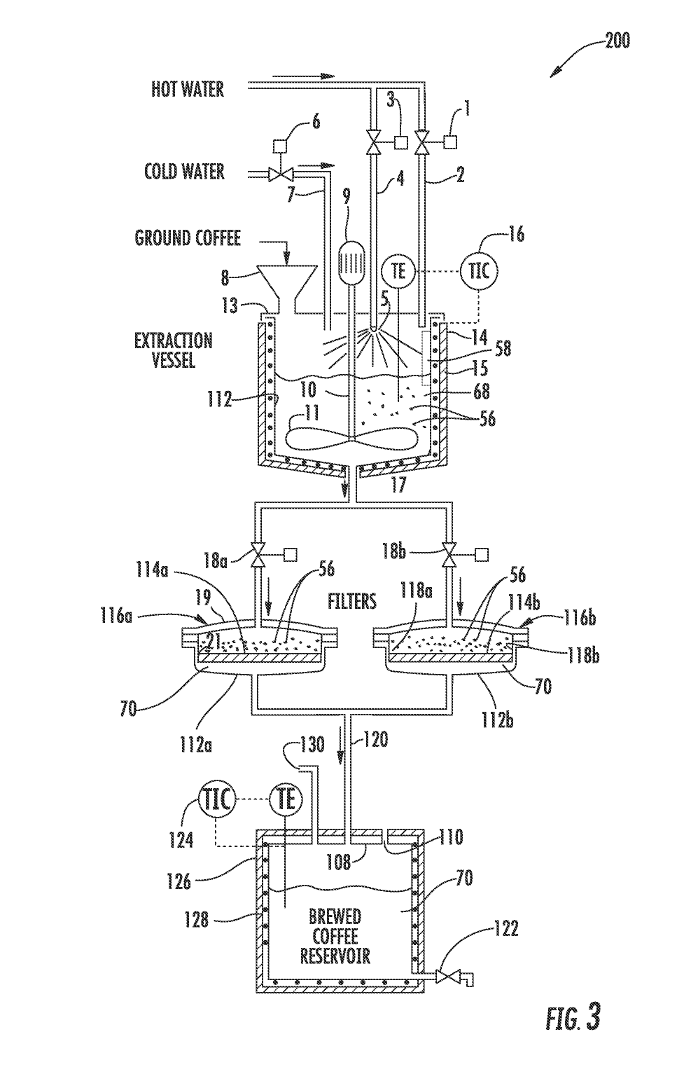

FIG. 3 shows a third embodiment 200 of the present invention, which provides for transfer of the coffee slurry 68 by gravity from the brew vessel 112 through the filter 114a, 114b and into the brewed coffee reservoir 108. In this option, neither a positive pressure pump 18 of FIG. 1 nor a vacuum pump 102 of FIG. 2 is used. The driving force for flow through the filter media is only the static head of slurry 68 resting on the filter media 114a, 114b. In order to achieve sufficiently rapid filtration to minimize continued brewing in the filtration step while the solids and liquid are still in contact, the filter media 114a, 114b must be chosen to be compatible with the particle size distribution of the ground coffee.

The description of the brewing step for the above embodiment 100 for Slurry Transfer and Filtration by Vacuum remains the same for this embodiment 200. A permanent vent is provided either on the top of the brewed coffee reservoir as shown in FIG. 2 (except without a vent valve 26), or on the side of each filter vessel base 112a, 112b. The permanent vent 130 is required to allow the liquid to drain through the filter as it displaces air inside the brewed coffee reservoir 108.

When coffee extraction is complete based on the desired brewing time selected by the user, either valve 18a or 18b is opened to allow coffee slurry 68 to flow by gravity from the bottom of the extraction vessel 112 through line 17 and through either valve 18a or 18b to one of the parallel in-line filter vessels 116a, 116b. Valves 18a and 18b can be set to direct slurry 68 to either filter vessel 116a, 116b. As described in connection with the above embodiments 50, 100, one of the filters 114a, 114b can receive slurry 68 while coffee grounds 56 are being removed from the other filter.

As in the previously described options, the brewed coffee 70 is separated from the extracted coffee solids 56 with high efficiency in the filter vessels 116a, 116b. The general filter design for this gravity flow option is the same as described in the previous options. However, to achieve rapid filtration of slurry 68 by gravity flow only, some modifications to the filter arrangement may be necessary. The filter media 114a, 114b in the filter basket 118a, 118b may consist of one or more individual filters in series to achieve optimum filtration of a particular coffee grind size. For example, one or more stainless steel and/or paper filters placed in series with the coarsest filter media contacting the incoming slurry first, followed by successively finer mesh filter media would be required to filter coffee with high separation efficiency and at greater filtration rates. The principal is that the coarsest particles are separated from the slurry 68 by the first filter. Successive filters receive slurry 68 of progressively lower solids concentration but finer average particle size. Another way to enhance the slurry filtration rate is to increase the cross sectional flow area of the filter media, which allows for shallower beds of grounds on each filter and, thereby, reduced flow resistance.

The previously described filter design, registration, sealing methods, quantity of filter vessels, filter changeout/pivot arrangements, brewed coffee holding and dispensing, and self-cleaning feature all apply to this gravity flow option.

It would be appreciated by those skilled in the art that various changes and modifications can be made to the illustrated embodiments without departing from the spirit of the present invention. All such modifications and changes are intended to be covered by the appended claims.

1. A beverage brewing system, comprising:
an extraction vessel having an open top end, an interior chamber and an exit port;
hopper means for directing beverage solids into the extraction vessel;
conduit means for directing water into the extraction vessel;
means for mixing the beverage solids and water into a slurry; water-soluble material being extractable from the beverage solids;
control means for heating and controlling the temperature of extraction of the water-soluble material from the beverage solids;
at least one filter vessel having an input port and an exit port; the exit port of the extraction vessel being connected to the input port of the at least one filter vessel; each of the at least one filter vessels including filter media;
means for routing the slurry from the extraction vessel through the at least one filter vessel and through the filter media; brewed beverage being provided at the exit port of the at least one filter vessel;
a brewed beverage reservoir having an input port and an exit port; the input port being connected to the exit port of the at least one filter vessel to received brewed beverage therethrough for delivery to and storage in the brewed beverage reservoir; and
a valve connected to the exit port of the brewed beverage reservoir; the valve permitting controlled dispensing of the brewed beverage from the brewed beverage reservoir.

2. The beverage brewing system of claim 1, wherein the at least one filter vessel is two or more filter vessels connected in parallel between the exit port of the extraction vessel and the input port of the brewed beverage reservoir.

3. The beverage brewing system of claim 1, wherein the means for routing the slurry is a positive pressure pump connected between the extraction vessel and the at least one filter vessel.

4. The beverage brewing system of claim 1, wherein the means for routing the slurry is a negative pressure vacuum pump connected to the brewed beverage reservoir.

5. The beverage brewing system of claim 1, wherein the means for routing the slurry is a negative pressure vacuum pump connected to the at least one filter vessel.

6. The beverage brewing system of claim 1, wherein the means for routing the slurry is gravity.

7. The beverage system of claim 1, wherein the means for mixing is a mechanical mixer selected from the group consisting of an agitation blade mixer and a magnetic mixer.

8. The beverage system of claim 1, further comprising:
a recycle return conduit having a first end and a second end; the first end of the recycle return connected to the exit port of the extraction vessel and the second end of the recycle return being in fluid communication with the interior chamber of the extraction chamber; the slurry being mixed using jet mixing by recycling slurry back into the extraction vessel via the recycle return conduit.

9. The beverage system of claim 1, wherein the slurry is mixed using both mechanical agitation and jet mixing by recycling slurry back into the extraction vessel.

10. The beverage system of claim 1, further comprising:
means for self-cleaning the system.

11. A process for brewing a beverage, comprising the steps of:
providing an extraction vessel having an open top end, an interior chamber and an exit port;
directing beverage solids into the extraction vessel;
directing water into the extraction vessel;
mixing the beverage solids and water into a slurry; water-soluble material being extractable from the beverage solids;
heating the slurry and controlling the temperature of extraction of the water-soluble material from the beverage solids;
directing the slurry with extracted water-soluble material to at least one filter vessel;
filtering the beverage solids from the slurry leaving brewed beverage;
routing brewed beverage into a brewed beverage reservoir;
dispensing brewed beverage from the brewed beverage reservoir.

12. The process of claim 11, wherein the at least one filter vessel is two or more filter vessels connected in parallel between the exit port of the extraction vessel and the input port of the brewed beverage reservoir.

13. The process of claim 11, wherein the slurry is directed to the at least one filter vessel by a positive pressure pump connected between the extraction vessel and the at least one filter vessel.

14. The process of claim 11, wherein the slurry is directed to the at least one filter vessel by a negative pressure vacuum pump connected to the brewed beverage reservoir.

15. The process of claim 11, wherein the slurry is directed to the at least one filter vessel by a negative pressure vacuum pump connected to the at least one filter vessel.

16. The process of claim 11, wherein the slurry is directed to the at least one filter vessel by gravity.

17. The process of claim 11, wherein the wherein the beverage solids and water are mixed into a slurry by a mechanical mixer selected from the group consisting of an agitation blade mixer and a magnetic mixer.

18. The process of claim 11, further comprising the steps of:
mixing the beverage solids and water into a slurry by jet mixing from recycling slurry from the exit port of the extraction vessel and back into the interior chamber of the extraction vessel.

19. The process of claim 11, wherein the beverage solids and water are mixed into a slurry by mechanical agitation and jet recycle mixing.

20. The process of claim 11, further comprising the step of:
cleaning the extraction vessel and the at least one filter vessel.
